(19) United States
(12) Patent Application Publication
(10) Pub. No.: US 2025/0265522 A1
(43) Pub. Date: Aug. 21, 2025

(54) INTELLIGENT WEB-BASED TASK PLANNING AND EXECUTION

(71) Applicant: Merlyn Mind, Inc., New York, NY (US)

(72) Inventors: ASHISH JAGMOHAN, Mount Kisco, NY (US); PRASENJIT DEY, Kolkata (IN); SATYA V. NITTA, Cross River, NY (US); RAVINDRANATH KOKKU, Yorktown Heights, NY (US); ADITYA VEMPATY, Yorktown Heights, NY (US); TAMER ABUELSAAD, Fishkill, NY (US); DEEPAK AKKIL, Helsinki (FI); AAKASH KUMAR NAIN, Baghpat (IN)

(21) Appl. No.: 18/625,088

(22) Filed: Apr. 2, 2024

(30) Foreign Application Priority Data
Feb. 20, 2024 (IN) 202441011875

(51) Int. Cl. G06Q 10/0631; G06F 40/20

(52) U.S. Cl. CPC G06Q 10/06316; G06F 40/20

(57) ABSTRACT

A system for completing tasks using the web is disclosed. The system is programmed to receive a user query for completing a task in natural language. The system is programmed to generate from the user query a first plan having a first sequence of website action steps using a large language model. Each website action step specifies a website and includes a request for performing an action on a website in natural language or network or software protocol language. To execute a website action step, the system is programmed to generate from a corresponding request a current plan having a current sequence of function action steps using a large language model. Each function action step specifies a function in the website's application programming interface and includes values for parameters of the function. To execute a function action step, the system is programmed to call the function with the parameter value.

### BENEFIT CLAIM

This application claims priority benefit under 35 U.S.C. § 119 (a)-(d) to Indian Patent Application number 202441011875 titled “INTELLIGENT WEB-BASED TASK PLANNING AND EXECUTION” and filed on Feb. 20, 2024, the entire contents of which are hereby incorporated by reference as if fully set forth herein.

### TECHNICAL FIELD

The present disclosure relates to web interactions, and more particularly to enhancing human interaction with websites to complete tasks using intelligent agents.

### BACKGROUND

The advent of the web changed the way humans interact with information. The original version of the web, also called Web 1.0, was mostly read-only, meaning it was meant for the users to read information from it but not to write information to it. When the need arose for the web to be more interactive, Web 2.0 was born where the key design principle was to make the web read-and-write. Subsequently, there was the arrival of Web 3.0 designed to be read-write-execute. What that means is that apart from allowing users to generate their own information, this new web will be machine-readable and hence allow for machine-machine communication and execution of applications through exposed web services. It would be helpful now to further improve the way humans interact with information through the web.

### SUMMARY

The appended claims may serve as a summary of the invention.

### BRIEF DESCRIPTION OF THE DRAWINGS

Example embodiments will now be described by way of non-limiting examples with reference to the accompanying drawings, in which:

FIG. 1 illustrates an example networked computer system in which various embodiments may be practiced;

FIG. 2 illustrates an example list of website action steps to be executed on a website and results of executing the website action steps in accordance with disclosed embodiments.

FIG. 3 illustrates example portions of a web API manifest of a website in accordance with disclosed embodiments.

FIG. 4 illustrates an example process performed by a computer server in accordance with disclosed embodiments.

FIG. 5 illustrates a computer system upon which various embodiments may be implemented.

### DETAILED DESCRIPTION OF CERTAIN EMBODIMENTS

In the following description, for the purposes of explanation, numerous specific details are set forth in order to provide a thorough understanding of the example embodiment(s) of the present invention. It will be apparent, however, that the example embodiment(s) may be practiced without these specific details. In other instances, well-known structures and devices are shown in block diagram form in order to avoid unnecessarily obscuring the example embodiment(s).

### 1. GENERAL OVERVIEW

A system for completing tasks using the web is disclosed. The system is programmed to receive a user query for completing a task in natural language. The system is programmed to generate from the user query a first plan having a first sequence of website action steps using a large language model (LLM). Each website action step specifies a website and includes a request for performing an action on a website in natural language or network or software protocol language. To execute a website action step, the system is programmed to generate from a corresponding request a current plan having a current sequence of function action steps using an LLM. Each function action step specifies a function in the website's application programming interface (API) and includes values for parameters of the function. To execute a function action step, the system is programmed to call the function with the parameter value.

In some embodiments, the system is programmed to receive a natural language query from a user to complete a task using the web. The query could be for submitting specific data to a particular party, obtaining an item having particular characteristics, or any other task that can be accomplished using the web. For example, the query could be “Get a blue cashmere sweater.”

In some embodiments, the system is programmed to then plan a first sequence of website action steps using a first LLM. Each website action steps specifies a website and includes a request for performing an action on the website. The system can be configured to train the first LLM through initial prompting or fine tuning with data that shows a trajectory of requests and website responses. The next website action step of the first sequence can be generated based on a result of executing a current website action step. For example, the first website action step can specify the website for a search engine and includes a request of “Search for a blue cashmere sweater.” The second website action step can specify the same website and includes a request of “Select the first search hit.” The third website action step can specify a website corresponding to the first search hit and includes a request of “Purchase the item.”

In some embodiments, to execute a current website action step, the system is programmed to plan a current sequence of function action steps using a current LLM. Each function action steps specifies a function in the website's API and includes values of parameters of the function such that a function can be readily called. The system can be configured to train the current LLM through initial prompting or fine tuning with data that shows a trajectory of function calls and website responses. The next function action step of the current sequence can be generated based on a result of executing a current function action step. For example, for the request of “Search for a blue cashmere sweater.”, the current sequence of function action steps can specify one or more functions in the website's API with appropriate parameter values, the execution of which leads to entering the request into a search field of the current webpage and hitting a Submit or Enter button to send the request to the search engine or the web server associated with the website.

In some embodiments, the system is programmed to collect the result of executing the current sequence of function action steps as the result of executing the current website action step, and the result of executing the first sequence of website action steps as the response to the query. The system is programmed to then present the response to the user.

The system disclosed herein has several technical benefits. The system improves Web 3.0 by allowing humans to continue conversing with the huge web of websites in natural language while completing complex tasks with the assistance of intelligent agents, such as LLMs. In addition, the system establishes a clean and efficient framework that distributes work for completing complex tasks based on a hierarchy of a higher, website level and a lower, API level. This framework enables each LLM utilized at any particular level to be trained with data of a manageable scope, which leads to higher accuracy and a reduced chance of hallucination. This framework also bridges and extends the capabilities of existing LLMs for either website traversal or generic function calling to streamlining human interaction with webpages. In addition, this framework promotes standardization and understandability and of an improved web architecture from every website publishing the website's API. Moreover, the framework is flexible enough to allow appropriate human invention for authentication and validation purposes.

### 2. EXAMPLE COMPUTING ENVIRONMENTS

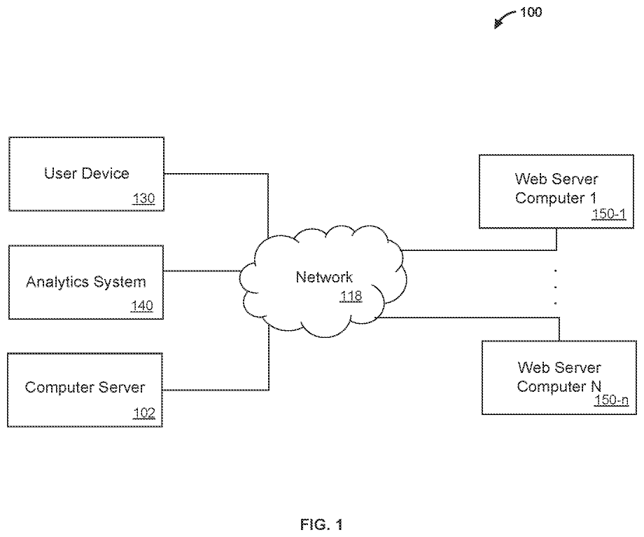

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, a networked computer system 100 comprises a computer server (“server”) 102, a user device 130, an analytics system 140, and one or more web server computers 150-1 through 150-n, which are communicatively coupled through direct physical connections or via a network 118.

In some embodiments, the server 102 is programmed or configured to process a query for completing a task using the web by planning and executing one or more website action steps, each specifying a website and including a request for an action to be performed on the website. The processing can be performed using one or more LLMs. The server 102 can comprise any centralized or distributed computing facility with sufficient computing power in data processing, data storage, and network communication for performing the above-mentioned functions. In certain embodiments, the server 102 is integrated into the user device 130.

In some embodiments, the user device 130 is programmed or configured to process a request for an action to be performed on a website by planning and executing one or more function action steps, each specifying a function in the website's API and including values for parameters of the function. The processing can be performed using one or more LLMs and a web client, such as a web browser, or a web server. The user device 130 can comprise a personal computing device, such as s desktop computer, laptop computer, tablet computer, smartphone, or wearable device.

In some embodiments, the analytics system 140 is programmed or configured to receive prompts as inputs, process the inputs using artificial intelligence (AI) techniques, including trained large LLMs based on artificial neural networks, to generate outputs, and deliver the outputs. The analytics system 140 can generally be similar to the server 102 and comprise any computing facility with sufficient computing power in data processing, data storage, and network communication for performing the above-mentioned functions.

In some embodiments, each of the web server computers 150-1 through 150-n is programmed or configured to respond to requests submitted by the user device 130 via a web client in processing the one or more function action steps. Each of the web server computers 150-1 through 150-n can generally be similar to the server 102 and comprise any computing facility with sufficient computing power in data processing, data storage, and network communication for performing the above-mentioned functions. In certain embodiments, each of the web server computers 150-1 through 150-n can also be configured to process a request for an action to be performed on a website.]

The network 118 may be implemented by any medium or mechanism that provides for the exchange of data between the various elements of FIG. 1. Examples of the network 118 include, without limitation, one or more of a cellular network, communicatively coupled with a data connection to the computing devices over a cellular antenna, a near-field communication (NFC) network, a Local Area Network (LAN), a Wide Area Network (WAN), or the Internet, a terrestrial or satellite link.

In some embodiments, the user device 130 is programmed to receive a query from a user for completing a task using the web. The user device is programmed to process the query by iteratively submitting input data to the analytics system 140 and receiving output data, which enables the planning of one or more website action steps, each specifying a website and including a request for performing an action on the website. The user device 130 is programmed to further execute each website action step by iteratively submitting additional input data to the analytics system 140 and receiving additional output data, which enables the planning of one or more function action steps, each specifying a function in a corresponding website's API and including values for parameters of the function. The user device 130 is programmed to further execute the function with the parameter values, which can lead to submitting web requests to one of the web server computers 150-1 through 150-n and receiving web responses from the web server computer. The user device 130 is programmed to utilize the result of executing all the function action steps in response to the request for performing an action on the website. Furthermore, the user device 130 is programmed to present the result of executing all the website action steps in response to the query.

### 3. FUNCTIONAL DESCRIPTIONS

### 3.1. System-Level Planning and Execution

In some embodiments, the user device 130 is programmed to receive a query to complete a task on the web, which can be in natural language. For example, the query can be “I would like a pair of size 10 sneakers for less than $100.” The user device 130 can be programmed to process this query directly or offload the processing to another user device, such as the server 102. The discussion below applies to the latter. The server 102 is programmed to receive and process this query by planning and executing one or more website action steps. Each website action step indicates a website and a request for an action to be performed on the website, where the request can again be in natural language. The website can be represented by the domain name of the website, an address of the homepage, the address of another location within the website, or any identifier that is readily mapped to any of the aforementioned representations. To execute a website action step, the server 102 is programmed to send the website action step to the user device 130 or another device, as discussed in Section 3.2. The result of executing one website action step can be used to plan the next website action step. The result typically in Extensible Markup Language (XML) or Hypertext Markup Language (HTML) can be represented as a text-only version using a web browser or another similar tool, which can help leverage the power of LLMs, as further discussed below. Furthermore, the server 102 is programmed to transmit the final result of executing the one or more website action steps as the response to the query back to the user device 130.

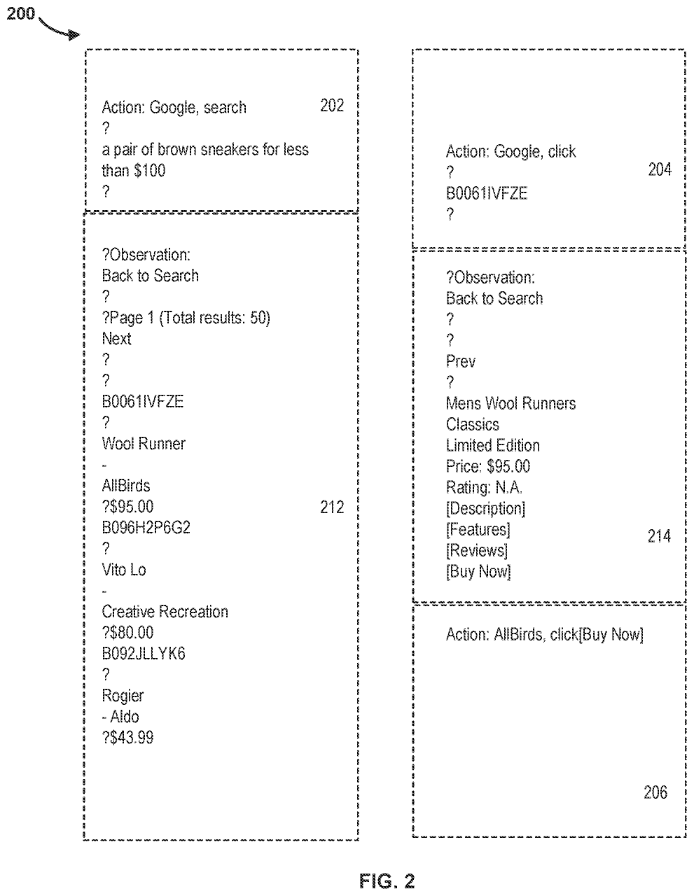

FIG. 2 illustrates an example list of website action steps to be executed on a website and results of executing the website action steps in accordance with disclosed embodiments. For example, the first website action step can correspond to the item 202 in FIG. 2 that indicates the website for a search engine and the request of “Search for a pair of size 10 sneakers for less than $100.” The result of executing this first website action step can correspond to the item 212 that includes the first few hits of 50 search hits. The second website action step, which is generated in response to the result of executing the first website action step, can correspond to the item 204 that indicates the same website and the request of “Select the first search hit.” Similarly, the result of executing the second website action step can correspond to the item 214 that includes details of the first search hit, and the third website action step can correspond to the item 206 that indicates the website offering the first search hit and the request of “Purchase the item.”, thereby completing processing of the query.

In some embodiments, the server 102 is programmed to plan one or more website action steps using a trained LLM, such as one offered by OpenAI, Inc. The server 102 can be configured to utilize the approach discussed in the paper by Yao et al. titled “REACT: SYNERGIZING REASONING AND ACTING IN LANGUAGE MODELS”, arXiv: 2210.03629v3 [cs.CL] 10 Mar. 2023, for instance. The server 102 can be programmed to obtain in-context learning examples and guide performance of a trained LLM in accordance with the Act system discussed in the paper using few-shot prompting, as illustrated in Table 6 of the paper. The server 102 could also be programmed to retrieve past examples of user queries and resultant trajectories from a database, in order to construct the few-shot prompt, using techniques similar to those discussed in the paper by Wang et al. titled “JARVIS-1: Open-world Multi-task Agents with Memory-Augmented Multimodal Language Models”, arXiv: 2311.05997v3 [cs.AI] 30 Nov. 2023. With the initial prompt indicating a full path or trajectory of responding to a query using the web, the trained LLM can learn to generate at any time a next portion of a trajectory given a current portion of the trajectory (subject to the memory limitation of the trained LLM). Specifically, the current portion could be the result of executing the current website action step (as the current prompt to the trained LLM) or the entire partial trajectory so far (as the current prompt combined with all the previous prompts), and the next portion (output from the trained LLM) could be the next website action step to execute.

In some embodiments, the server 102 is programmed to interleave additional website reasoning steps with website action steps. The server 102 can then be programmed to also obtain in-context learning examples and guide performance of a trained LLM in accordance with the ReAct system discussed in the paper using few-shot prompting, as also illustrated in Table 6 of the paper. The website reasoning steps can be generated as appropriate without requiring additional prompts following the initial prompt.

In some embodiments, the server 102 is programmed to obtain in-context learning example for various paths or trajectories to cover many possible scenarios. These scenarios can include handling errors, which leads to trying the same website or link repeatedly or trying another website or link. These scenarios can cover traversing a specific list of websites by visiting the websites directly or through links or traversing a specific list of links, in a specific order. These scenarios can also cover refining results of executing the website action steps iteratively, which could involve visiting the same website repeatedly or trying another website. Such refinement could be based on previous results, additional user inputs, or other static or dynamic environment factors, such as the current time.

In some embodiments, the server 102 is programmed to incorporate opportunities for user interaction. The server 102 can be configured to pause planning and executing website action steps in response to a user request to provide data and allow the user to provide the data any time. The server 102 can also be configured to deduce when additional data may be required from a user as part of its reasoning. For example, any action of potential importance, such as making a payment or expressing a criticism, may require a user to provide authentication or validation information. Utilizing the approach discussed in the paper by Yao et al., for instance, the server 102 can be programmed to generate additional system-level user action steps that instead indicates a user action and includes a request for specific data. Executing such an additional system-level user action step would lead to a pause for input data followed by a capture of the input data.

In some embodiments, the server 102 is programmed to maintain a database of user accounts containing user profiles and settings. The server 102 is programmed to then consult this database or simply the web initially in response to the query or subsequently in response to the result of executing a particular website action step, in order to enhance a prompt to the trained LLM operating in accordance with the ReAct system or another similar system. Specifically, the server 102 can be programmed to automatically convert a query or a result of executing a particular website action step into a question for more information. For example, the example query of “I would like a pair of size 10 sneakers for less than $100.” can be converted to a question in the form of “Does [the user's identifier] know anyone who wears size 10 sneakers [or shoes]? If so, provide more information about the person's preferences for sneakers.” The server 102 can be configured to then submit the question to a trained LLM in combination of contents of the database if available, and use the output data of the LLM to enhance the prompt.

In some embodiments, the server 102 is programmed to process a relatively complex query by breaking the query into sub-queries, executing them in an organized fashion while tracking the overall state of execution, and combining the results from executing them. The server 102 can be configured to utilize the approach discussed in the paper by Wei et al. titled “Chain-of-Thought Prompting Elicits Reasoning in Large Language Models”, arXiv: 2201.11903v6 [cs.CL] 10 Jan. 2023, for instance. The server 102 can be programmed to obtain in-context learning examples and guide performance of the chain-of-thought system discussed in the paper using few-shot prompting, as illustrated in Tables 25-28 of the paper. The server 102 can also be configured to utilize the approach discussed in the paper by Yao et al. titled “Tree of Thoughts: Deliberate Problem Solving with Large Language Models”, arXiv: 2305.10601v2 [cs.CL] 3 Dec. 2023, for instance. Similarly, the server 102 can be programmed to obtain in-context learning examples and guide performance of the tree-of-thought system using few-shot prompting.

### 3.2. Website-Level Planning and Execution

In some embodiments, the user device 130 that received the query to complete a task on the web or another user device or another user device is programmed to obtain information regarding a client-side API of each website of interest for a web client running by the user device 130, which interacts with the web server associated with the website. The user device 130 can also be programmed to obtain information regarding a server-side API of each website of interest and interact with the web server directly. The website's API can be published in a web API manifest or otherwise be made accessible to the user device 130 or any other device.

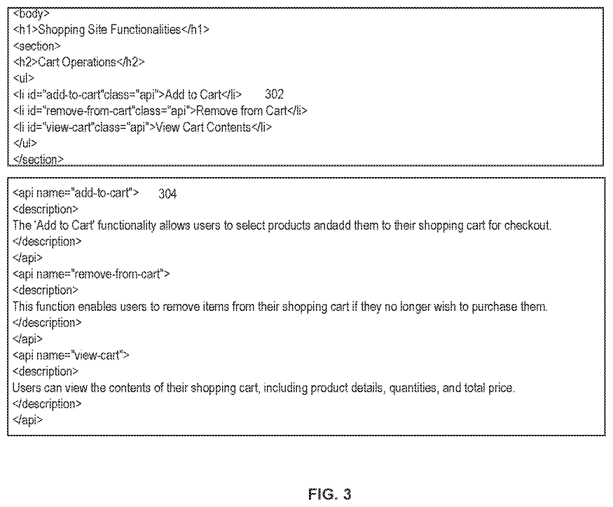

FIG. 3 illustrates example portions of a web API manifest of a website in accordance with disclosed embodiments. The manifest can utilize existing HTML syntax and elements, such as a list element 302 having an id attribute with a value of a function name and a class attribute with a value of “api” to indicate that this element specifies the name of a function in the website's API. Within the list element 302, there can be a nested list to similarly specify the name and type of each parameter of the function. The manifest can also incorporate new HTML elements, such as an api element 304 with an “api” tag and having a name attribute with a value of a function name to indicate that this element specifies the name of a function in the website's API. Within the api element 304, there can be a nested list to similarly specify the name and type of each parameter of the function.

Additional APIs can be supported by a web client that apply to all websites in general. The W3C DOM API, for example, is a client-side API that enables manipulation of HTML elements of a webpage based on the document management model (DOM) structure. Another example can be a client-side API that enables manipulation of HTML elements of a webpage based on computer vision. In the discussion below, these additional APIs can be considered as part of the website's API.

In some embodiments, the user device 130 is programmed to process a website action step that indicates a website and a request to perform an action on the website, such as “Search for a pair of size 10 sneakers for less than $100.”, by planning and executing one or more function action steps based on the website's API. The request can be in natural language. The request can also be in network or software protocol language, such as a JSON object containing some context information and an instruction as text. Each function action step indicates a function in the website's API and values for parameters of the function, which can be in the form of executable code (or some other form that can be further transformed into executable code using existing techniques). The result of executing one function action step can be used to plan the next function action step. The result typically in XML or HTML can be represented as a text-only version using a web browser or another similar tool. Furthermore, the user device 130 is programmed to present the final result of executing the one or more function action steps as the response to the request.

In some embodiments, each of the web server computers 150-1 through 150-n can similarly be configured to retrieve information regarding a client-side API of the associated website for a web client running by a user device, which interacts with the web server. The web server can also be programmed to retrieve information regarding a server-side API of the associated website. The web server is then programmed to process a website action step that indicates a website and a request to perform an action on the website. The result of executing one function action step can be used to plan the next function action step. Furthermore, the web server is programmed to present the final result of executing the one or more function action steps as the response to the request. The discussion below refers to the user device 130, but it could similarly refer to another user device or a web server.

For example, the first function action step can indicate a function in the website's (client-side) API and values for parameters of the function, the execution of which leads to entering the description of “a pair of size 10 sneakers for a less than $100” into a search field of the webpage and hitting a Submit button to send the description to the web server associated with the website to search a database for items that match the description. The result of executing this function action step can include the first few items of a list of 50 search hits. Alternatively, the first function action step can indicate a function in the website's API and values for parameters of the function, the execution of which leads to entering the description of “a pair of size 10 sneakers for less than $100” into a search field of the webpage only. The result of executing this function step can then include “void” or a general acknowledgement only. Depending on how the website's API is defined, one or more function action steps can be generated to execute one or more functions in the website's API to respond to the request.

In some embodiments, the user device 130 is programmed to plan and execute one or more function action steps (possibly interleaved with additional function reasoning steps) using a trained LLM. The user device 130 can be configured to utilize the approach discussed in the paper by Qin et al. titled “TOOLLLM: FACILITATING LARGE LANGUAGE MODELS TO MASTER 16000+REAL-WORLD APIS”, arXiv: 2307.16789v2 [cs.AI] 3 Oct. 2023, for instance. The user device 130 can be programmed to obtain a custom ToolBench by undergoing the API Collection phase, Instruction Generation phase, and Solution Path Annotation phase, as discussed in the paper, or incorporating user input. The user device 130 can be programmed to obtain a specific prompt based on the website's (server-side) API for a trained LLM for the Instruction Generation phase, as illustrated in Appendix A7 of the paper. The output of this trained LLM is a set of entries, each entry including a sample instruction specifying a sample request and a list of functions in the website's API related to the sample request. The user device 130 can also be programmed to then build a prompt based on each sample instruction and the specific text illustrated in Appendix A8 of the paper for a trained LLM that has function calling features to be applied to the website's API for the Solution Path Annotation phase. The output of this trained LLM specifies one or more functions in the website's API and values for parameters of the one or more functions. The user device is programmed to obtain code based on the output, execute the code, and have a conversation with the trained LLM based on a result of executing the code. The full conversation is thus a solution path specifying a sequence of functions in the website's API to be called with specific values for parameters of each function and a result of each call. Furthermore, the user device 130 can be programmed to fine-tune a trained LLM that has code generation features with pairs of an instruction and a corresponding solution path created during the Instruction Generation Phase and the Solution Path Annotation phase, respectively, to obtain the final trained LLM for planning and executing one or more function action steps.

In some embodiments, with the training data for the fine tuning indicating a full path or trajectory of responding to a request using the website's API, the fine-tuned system can learn to generate at any time a next portion of a trajectory given a current portion of the trajectory (subject to the memory limitation of the fine-tuned system). Specifically, the current portion could be the result of executing the current function action step (as the current prompt to the fine-tuned system) or the entire partial trajectory so far (as the current prompt combined with all the previous prompts), and the next portion (output from the fine-tuned system) could be the next function action step to execute. As noted above, the user device 130 can be configured to interleave additional function reasoning steps with function action steps. The function reasoning steps can be generated as appropriate without requiring additional prompts.

In some embodiments, the user device 130 is programmed to incorporate opportunities for user interaction. The user device 130 can be configured to pause planning and executing function action steps in response to a user request to provide data and allow the user to provide the data any time. The user device 130 can also be configured to deduce when additional data may be required from a user as part of its reasoning. For example, any action of potential importance, such as making a payment or expressing a criticism, may require a user to provide authentication or validation information. Utilizing the approach discussed in the paper by Qin et al., for instance, the user device 130 can be programmed to generate additional website-level user action steps that instead indicates a user action and includes a request for specific data. Executing such an additional website-level user action step would lead to a pause for input data followed by a capture of input data.

In some embodiments, the user device 130 is programmed to process a relatively complex request by breaking the request into sub-requests, executing them in an organized fashion while tracking the overall state of execution, and combining the results from executing them. The user device 130 can be configured to utilize the approach discussed in the paper arXiv: 2201.11903v6 [cs.CL] 10 Jan. 2023 noted above. The user device 130 can be programmed to obtain in-context learning examples and guide performance of the chain-of-thought system using few-shot prompting. The user device 130 can also be configured to utilize the approach discussed in the paper arXiv: 2305.10601v2 [cs.CL] 3 Dec. 2023 noted above. The user device 130 can be programmed to obtain in-context learning examples and guide performance of the chain-of-thought system using few-shot prompting.

### 4. EXAMPLE PROCESSES

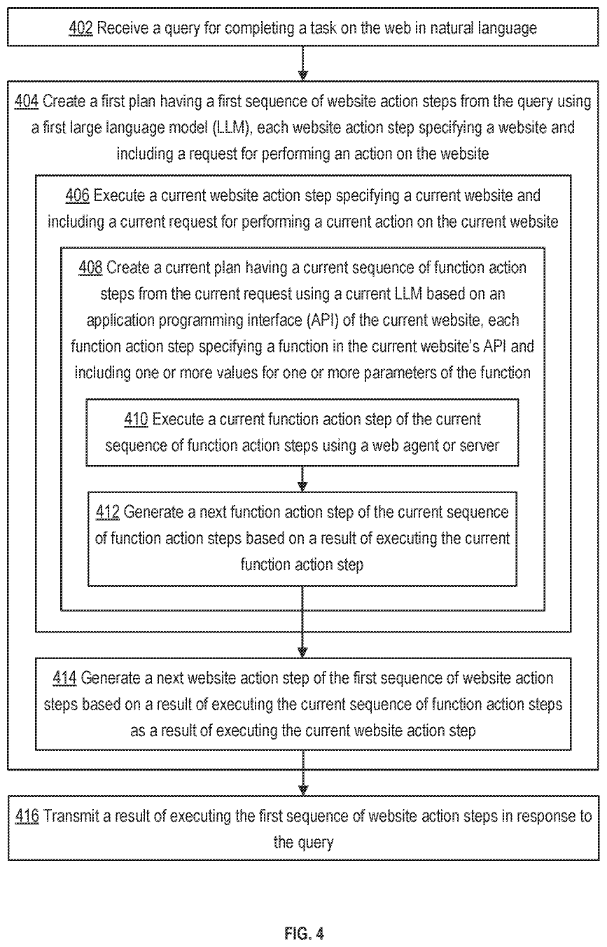

FIG. 4 illustrates an example process of completing tasks using the web in accordance with some embodiments described herein. FIG. 4 is shown in simplified, schematic format for purposes of illustrating a clear example and other embodiments may include more, fewer, or different elements connected in various manners. FIG. 4 is intended to disclose an algorithm, plan, or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In step 402, a system is programmed or configured to receive a query for completing a task using the web in natural language.

In step 404, the system is programmed or configured to create a first plan having a first sequence of website action steps from the query using a first LLM, each website action step specifying a website and including a request for performing an action on the website in natural language. Step 404 comprises step 406 and step 414.

In some embodiments, the system is configured to send an enhancing prompt indicating a request for additional information based on the query and data of a user account for a user associated with the query to a second LLM. The system is further configured to replace the query by output data from the second LLM.

In some embodiments, in creating the first plan, the system is programmed or configured to send an initial prompt having in-context learning examples showing a trajectory of user requests for performing actions on websites and responses from the websites to the first LLM. In certain embodiments, the trajectory includes retrying to communicate with a specific website that was unreachable or returned an error message.

In some embodiments, the first plan includes a website reasoning step indicating a reasoning of a current state of the first LLM. In other embodiments, the first plan includes a system-level user action step indicating a user action and including a request for user data.

In step 406, the system is programmed or configured to execute a current website action step specifying a current website and including a current request for performing a current action on the current website. Step 406 comprises step 408.

In step 408, the system is programmed or configured to create a current plan having a current sequence of function action steps from the current request using a current LLM based on an API of the current website, each function action step specifying a function in the current website's API and including one or more values for one or more parameters of the function. Step 408 comprises step 410 and step 412.

In some embodiments, the system is configured to access a web API manifest indicating the current website's API, the web API manifest including a tag or an attribute signaling information regarding a particular function in the current website's API. In certain embodiments, the current website's API includes a client-side web API that enables manipulation of webpage elements using DOM or computer vision.

In some embodiments, in creating the current plan, the system is configured to fine-tune a certain LLM with training data showing a trajectory of parameterized calls of functions of the current website's API and responses from the current website.

In some embodiments, the current plan includes a function reasoning step indicating a reasoning of a current state of the current LLM. In other embodiments, the current plan includes a website-level user action step indicating a user action and including a request for user data.

In step 410, the system is programmed or configured to execute a current function action step of the current sequence of function action steps using a web agent or server. In some embodiments, the result of executing the current function action step is executable code.

In step 412, the system is programmed or configured to generate a next function action step of the current sequence of function action steps based on a result of executing the current function action step.

In some embodiments, in generating the next function action step the system is configured to send a prompt including the result of executing the current function action step to the current LLM.

In step 414, the system is programmed or configured to generate a next website action step of the first sequence of website action steps based on a result of executing the current sequence of function action steps as a result of executing the current website action step.

In some embodiments, in generating the next website action step, the system is configured to send a subsequent prompt including the result of executing the current website action step to the first LLM.

In step 416, the system is programmed or configured to transmit a result of executing the first sequence of website action steps in response to the query.

### 5. EXAMPLE IMPLEMENTATION

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

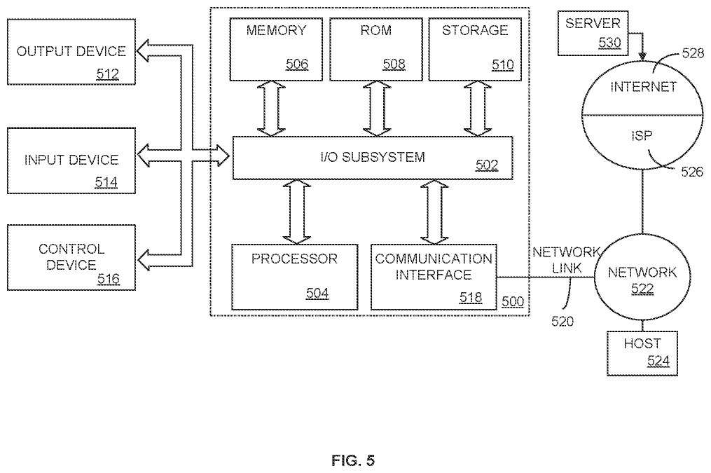

FIG. 5 is a block diagram that illustrates an example computer system with which an embodiment may be implemented. In the example of FIG. 5, a computer system 500 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 500 includes an input/output (I/O) subsystem 502 which may include a bus and/or other communication mechanism(s) for communicating information and/or instructions between the components of the computer system 500 over electronic signal paths. The I/O subsystem 502 may include an I/O controller, a memory controller and at least one I/O port. The electronic signal paths are represented schematically in the drawings, for example as lines, unidirectional arrows, or bidirectional arrows.

At least one hardware processor 504 is coupled to I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor or Advanced RISC Machines (ARM) processor. Processor 504 may comprise an integrated arithmetic logic unit (ALU) or may be coupled to a separate ALU.

Computer system 500 includes one or more units of memory 506, such as a main memory, which is coupled to I/O subsystem 502 for electronically digitally storing data and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, can render computer system 500 into a special-purpose machine that is customized to perform the operations specified in the instructions.

Computer system 500 further includes non-volatile memory such as read only memory (ROM) 508 or other static storage device coupled to I/O subsystem 502 for storing information and instructions for processor 504. The ROM 508 may include various forms of programmable ROM (PROM) such as erasable PROM (EPROM) or electrically erasable PROM (EEPROM). A unit of persistent storage 510 may include various forms of non-volatile RAM (NVRAM), such as flash memory, or solid-state storage, magnetic disk, or optical disk such as CD-ROM or DVD-ROM, and may be coupled to I/O subsystem 502 for storing information and instructions. Storage 510 is an example of a non-transitory computer-readable medium that may be used to store instructions and data which when executed by the processor 504 cause performing computer-implemented methods to execute the techniques herein.

The instructions in memory 506, ROM 508 or storage 510 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement Transmission Control Protocol/Internet Protocol (TCP/IP), Hypertext Transfer Protocol (HTTP) or other communication protocols; file processing instructions to interpret and render files coded using HTML, XML, Joint Photographic Experts Group (JPEG), Moving Picture Experts Group (MPEG) or Portable Network Graphics (PNG); user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 500 may be coupled via I/O subsystem 502 to at least one output device 512. In one embodiment, output device 512 is a digital computer display. Examples of a display that may be used in various embodiments include a touch screen display or a light-emitting diode (LED) display or a liquid crystal display (LCD) or an e-paper display. Computer system 500 may include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators, or servos.

At least one input device 514 is coupled to I/O subsystem 502 for communicating signals, data, command selections or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be a touchpad, a mouse, a trackball, or cursor direction keys for communicating direction information and command selections to processor 504 and for controlling cursor movement on the output device 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

In another embodiment, computer system 500 may comprise an internet of things (IoT) device in which one or more of the output device 512, input device 514, and control device 516 are omitted. Or, in such an embodiment, the input device 514 may comprise one or more cameras, motion detectors, thermometers, microphones, seismic detectors, other sensors or detectors, measurement devices or encoders and the output device 512 may comprise a special-purpose display such as a single-line LED or LCD display, one or more indicators, a display panel, a meter, a valve, a solenoid, an actuator or a servo.

When computer system 500 is a mobile computing device, input device 514 may comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 may include hardware, software, firmware, and interfaces for generating position reporting packets, notifications, pulse or heartbeat signals, or other recurring data transmissions that specify a position of the computer system 500, alone or in combination with other application-specific data, directed toward host computer 524 or server 530.

Computer system 500 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying at least one sequence of at least one instruction to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage 510 either before or after execution by processor 504.

Computer system 500 also includes a communication interface 518 coupled to I/O subsystem 502. Communication interface 518 provides a two-way data communication coupling to network link(s) 520 that are directly or indirectly connected to at least one communication network, such as a network 522 or a public or private cloud on the Internet. For example, communication interface 518 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 522 broadly represents a LAN, WAN, campus network, internetwork, or any combination thereof. Communication interface 518 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic, or optical signals over signal paths that carry digital data streams representing various types of information.

Network link 520 typically provides electrical, electromagnetic, or optical data communication directly or through at least one network to other data devices, using, for example, satellite, cellular, Wi-Fi, or BLUETOOTH technology. For example, network link 520 may provide a connection through a network 522 to a host computer 524.

Furthermore, network link 520 may provide a connection through network 522 or to other computing devices via internetworking devices and/or computers that are operated by an Internet Service Provider (ISP) 526. ISP 526 provides data communication services through a world-wide packet data communication network represented as internet 528. A server 530 may be coupled to internet 528. Server 530 broadly represents any computer, data center, virtual machine, or virtual computing instance with or without a hypervisor, or computer executing a containerized program system such as DOCKER or KUBERNETES. Server 530 may represent an electronic digital service that is implemented using more than one computer or instance and that is accessed and used by transmitting web services requests, Uniform Resource Locator (URL) strings with parameters in HTTP payloads, API calls, app services calls, or other service calls. Computer system 500 and server 530 may form elements of a distributed computing system that includes other computers, a processing cluster, server farm or other organization of computers that cooperate to perform tasks or execute applications or services. Server 530 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. Server 530 may comprise a web application server that hosts a presentation layer, application layer and data storage layer such as a relational database system using structured query language (SQL) or NoSQL, an object store, a graph database, a flat file system or other data storage.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage 510, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 504. While each processor 504 or core of the processor executes a single task at a time, computer system 500 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 6. EXTENSIONS AND ALTERNATIVES

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A non-transitory, computer-readable storage medium storing one or more sequences of instructions which when executed cause one or more processors to perform:
receiving a query for completing a task using the web in natural language;
creating a first plan having a first sequence of website action steps from the query using a first large language model (LLM), each website action step specifying a website and including a request for performing an action on the website, comprising:
executing a current website action step specifying a current website and including a current request for performing a current action on the current website, comprising:
creating a current plan having a current sequence of function action steps from the current request using a current LLM based on an application programming interface (API) of the current website, each function action step specifying a function in the current website's API and including one or more values for one or more parameters of the function, comprising:
executing a current function action step of the current sequence of function action steps; and
generating a next function action step of the current sequence of function action steps based on a result of executing the current function action step; and
generating a next website action step of the first sequence of website action steps based on a result of executing the current sequence of function action steps as a result of executing the current website action step;
transmitting a result of executing the first sequence of website action steps in response to the query.

2. The non-transitory, computer-readable storage medium of claim 1, creating the first plan further comprising sending an initial prompt having in-context learning examples showing a trajectory of user requests for performing actions on websites and responses from the websites to the first LLM.

3. The non-transitory, computer-readable storage medium of claim 2, the trajectory including retrying to communicate with a specific website that was unreachable or returned an error message.

4. The non-transitory, computer-readable storage medium of claim 2, generating the next website action step comprising sending a subsequent prompt including the result of executing the current website action step to the first LLM.

5. The non-transitory, computer-readable storage medium of claim 1, the first plan including a website reasoning step indicating a reasoning of a current state of the first LLM.

6. The non-transitory, computer-readable storage medium of claim 1, the first plan including a system-level user action step indicating a user action and including a request for user data.

7. The non-transitory, computer-readable storage medium of claim 1, the one or more sequences of instructions which when executed further cause the one or more processors to perform:
sending an enhancing prompt indicating a request for additional information based on the query and data of a user account for a user associated with the query to a second LLM;
replacing the query by output data from the second LLM.

8. The non-transitory, computer-readable storage medium of claim 1, the one or more sequences of instructions which when executed further cause the one or more processors to perform
accessing a web API manifest indicating the current website's API,
the web API manifest including a tag or an attribute signaling information regarding a particular function in the current website's API.

9. The non-transitory, computer-readable storage medium of claim 1, the current website's API including a client-side web API that enables manipulation of webpage elements using DOM or computer vision.

10. The non-transitory, computer-readable storage medium of claim 1, the result of executing the current function action step being executable code.

11. The non-transitory, computer-readable storage medium of claim 1, creating the current plan further comprising fine-tuning a certain LLM with training data showing a trajectory of parameterized calls of functions of the current website's API and responses from the current website.

12. The non-transitory, computer-readable storage medium of claim 1, generating the next function action step comprising sending a prompt including the result of executing the current function action step to the current LLM.

13. The non-transitory, computer-readable storage medium of claim 1, the current plan including a function reasoning step indicating a reasoning of a current state of the current LLM.

14. The non-transitory, computer-readable storage medium of claim 1, the current plan including a website-level user action step indicating a user action and including a request for user data.

15. A computer-implemented method of completing tasks using the web, comprising:
receiving, by a processor, a query for completing a task using the web in natural language;
creating, by the processor, a first plan having a first sequence of website action steps from the query using a first LLM, each website action step specifying a website and including a request for performing an action on the website, comprising:
executing a current website action step specifying a current website and including a current request for performing a current action on the current website, comprising:
creating a current plan having a current sequence of function action steps from the current request using a current LLM based on an application programming interface (API) of the current website, each function action step specifying a function in the current website's API and including one or more values for one or more parameters of the function, comprising:
executing a current function action step of the current sequence of function action steps; and
generating a next function action step of the current sequence of function action steps based on a result of executing the current function action step; and
generating a next website action step of the first sequence of website action steps based on a result of executing the current sequence of function action steps as a result of executing the current website action step;
transmitting a result of executing the first sequence of website action steps in response to the query.

16. The computer-implemented method of claim 15, creating the first plan further comprising sending an initial prompt having in-context learning examples showing a trajectory of user requests for performing actions on websites and responses from the websites to the first LLM.

17. The computer-implemented method of claim 16, generating the next website action step comprising sending a subsequent prompt including the result of executing the current website action step to the first LLM.

18. The computer-implemented method of claim 15, further comprising
accessing a web API manifest indicating the current website's API,
the web API manifest including a tag or an attribute signaling information regarding a particular function in the current website's API.

19. The computer-implemented method of claim 15, creating the current plan further comprising fine-tuning a certain LLM with training data showing a trajectory of parameterized calls of functions of the current website's API and responses from the current website.

20. The computer-implemented method of claim 15, generating the next function action step comprising sending a prompt including the result of executing the current function action step to the current LLM.
